(19) United States
(12) Patent Application Publication
(10) Pub. No.: US 2008/0095316 A1
(43) Pub. Date: Apr. 24, 2008

(54) ANODE ASSEMBLY BEARING APPARATUS FOR AN X-RAY DEVICE

(75) Inventors: Liangheng Qiu, Waukesha, WI (US); Carey Shawn Rogers, Brookfield, WI (US); Michael J. Danyluk, Waukesha, WI (US); Thomas Dean Schaefer, Brookfield, WI (US)

Correspondence Address: PETER VOGEL;GE HEALTHCARE, 3000 N. GRANDVIEW BLVD., SN-477, WAUKESHA, WI, 53188, US

(73) Assignee: General Electric Company, Schenectady, NY (US)

(21) Appl. No.: 11/539,734

(22) Filed: Oct. 9, 2006

(51) Int. Cl. H01J 35/00; H01J 35/10

(52) U.S. Cl. 378/132; 378/144

(57) ABSTRACT

The present application discloses an anode assembly for an x-ray device. The anode assembly includes an anode and an anode shaft mounted to the anode. The anode assembly additionally includes a plurality of ceramic bearing balls adapted to rotatably support the anode shaft. In an embodiment, a plurality of metallic bearing balls are also provided to rotatably support the anode shaft. In another embodiment, the plurality of ceramic bearing balls and the plurality of metallic bearing balls have a solid lubricant coating.

### FIELD OF THE INVENTION

This invention generally relates to a bearing apparatus for an X-ray device such as an x-ray tube for a medical imaging device.

### BACKGROUND OF THE INVENTION

X-ray tubes generally include a cathode assembly and an anode assembly disposed within a vacuum vessel. The cathode assembly is positioned at some distance from the anode assembly, and a potential voltage difference is maintained therebetween. The anode assembly includes an anode having a target track or impact zone that is generally fabricated from a refractory metal with a high atomic number, such as tungsten or tungsten alloy. The cathode assembly emits electrons that are accelerated across the potential difference, impacting the target track of the anode assembly at high velocity. A small fraction of the kinetic energy of the electrons is converted to high energy electromagnetic radiation, or x-rays, while the balance is contained in back scattered electrons or converted to heat. The x-rays are emitted in all directions, emanating from the focal spot, and may be directed out of the vacuum vessel. After exiting the vacuum vessel, the x-rays are directed to penetrate an object, such as human anatomical parts for medical examination and diagnostic procedures. The x-rays transmitted through the object are intercepted by a detector and an image is formed of the internal anatomy.

Heat is generated in the anode as the electrons from the cathode assembly impact the target track. The anode is preferably rotated so that the electron beam does not focus on the same portion of the target track and thereby cause the accumulation of heat in a localized area. Accordingly, the anode assembly includes a bearing device configured to rotatably support the anode, and a stator is provided to selectively rotate the anode. Heat from the anode that is transferred to the bearing device can impact bearing performance and durability.

### SUMMARY OF THE INVENTION

The above-mentioned shortcomings, disadvantages and problems are addressed herein which will be understood by reading and understanding the following specification.

The present invention provides an anode assembly for an x-ray device. The anode assembly includes an anode and an anode shaft mounted to the anode. The anode assembly additionally includes a plurality of ceramic bearing balls that are preferably comprised of silicon nitride (Si3N4) and that are adapted to rotatably support the anode shaft. In an embodiment of the invention, a plurality of metallic bearing balls that are preferably comprised of steel are also provided to rotatably support the anode shaft. The present invention additionally provides an x-ray device incorporating the previously described anode assembly.

In another embodiment, the plurality of ceramic bearing balls and the plurality of metallic bearing balls have a solid lubricant coating that is preferably comprised of silver.

In another embodiment, the anode assembly includes a first outer race adapted to retain the plurality of ceramic bearing balls in a radially outer direction, and a second outer race adapted to retain the plurality of metallic bearing balls in a radially outer direction.

In another embodiment, the anode shaft defines a first bearing groove adapted to retain the plurality of ceramic bearing balls in a radially inner direction, and the anode shaft defines a second bearing groove adapted to retain the plurality of metallic bearing balls in a radially inner direction.

Various other features, objects, and advantages of the invention will be made apparent to those skilled in the art from the accompanying drawings and detailed description thereof.

### BRIEF DESCRIPTION OF THE DRAWINGS

FIG. 1 is a partially cutaway perspective view of an x-ray tube with the stator exploded to reveal a portion of the anode assembly; and

FIG. 2 is a more detailed sectional view of the anode assembly of FIG. 1.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

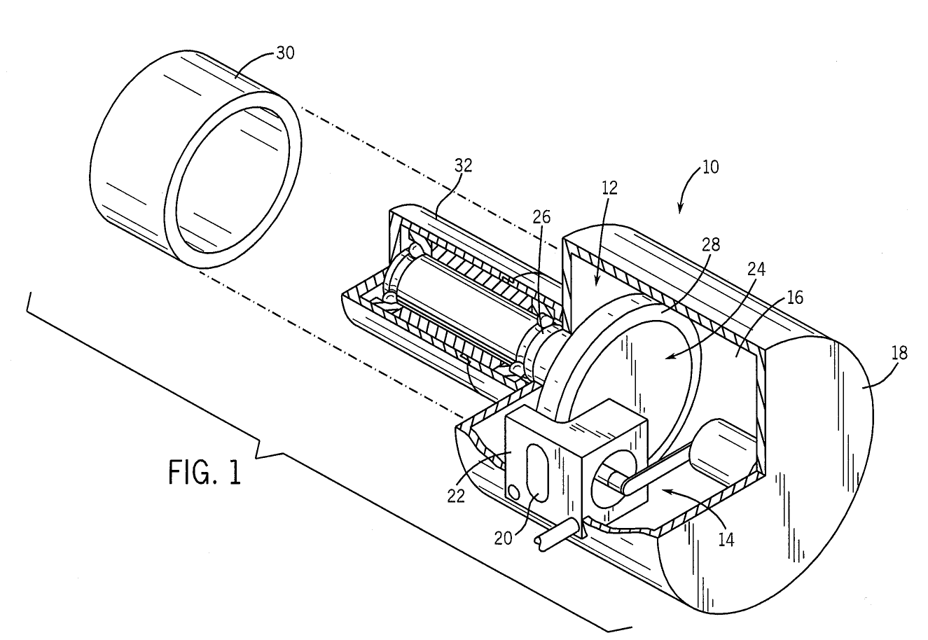

Referring to FIG. 1, a partially cut-away perspective view of an x-ray tube 10 is shown. The x-ray tube 10 includes an anode assembly 12 and a cathode assembly 14 which are at least partially disposed in a vacuum 16 within a vacuum enclosure or vessel 18. It should be appreciated that the x-ray tube 10 is shown for exemplary purposes, and that the anode assembly 12 may be implemented with other x-ray tube configurations.

A stream of electrons (not shown) are accelerated from the cathode assembly 14 toward the anode assembly 12. The stream of electrons strike a focal spot (not shown) on the anode assembly 12 and produce high frequency electromagnetic waves (not shown), or x-rays, and residual energy. The residual energy is absorbed by the components of the x-ray tube 10 as heat. The x-rays are directed through the vacuum 16 toward an aperture 20 in a thermal storage assembly 22 that is interposed between the cathode assembly 14 and the anode assembly 12. Aperture 20 collimates the x-rays thereby reducing the radiation dosage received by a patient.

The anode assembly 12 includes a generally disc-shaped anode 24 secured to one end of an anode shaft 26. The anode 24 includes a target track or impact zone 28 that is generally fabricated from a refractory metal with a high atomic number such as tungsten or tungsten alloy. Heat is generated in the anode assembly as the electrons from the cathode assembly 14 impact the target track 28. For example, the temperature of the anode focal spot (not shown) can run above 2,000 degrees C. The anode 24 is preferably rotated so that the electron beam (not shown) from the cathode assembly 14 does not focus on the same portion of the target track 28 and thereby cause the accumulation of heat in a localized area. Accordingly, a generally cylindrical stator 30 is provided to selectively rotate the anode shaft 26 and the anode 24 attached thereto. The stator 30 is depicted in FIG. 1 as being exploded from the remainder of the x-ray tube 10 in order to more clearly show the anode assembly 12, however, it should be appreciated that the stator 30 is actually assembled around the anode housing 32.

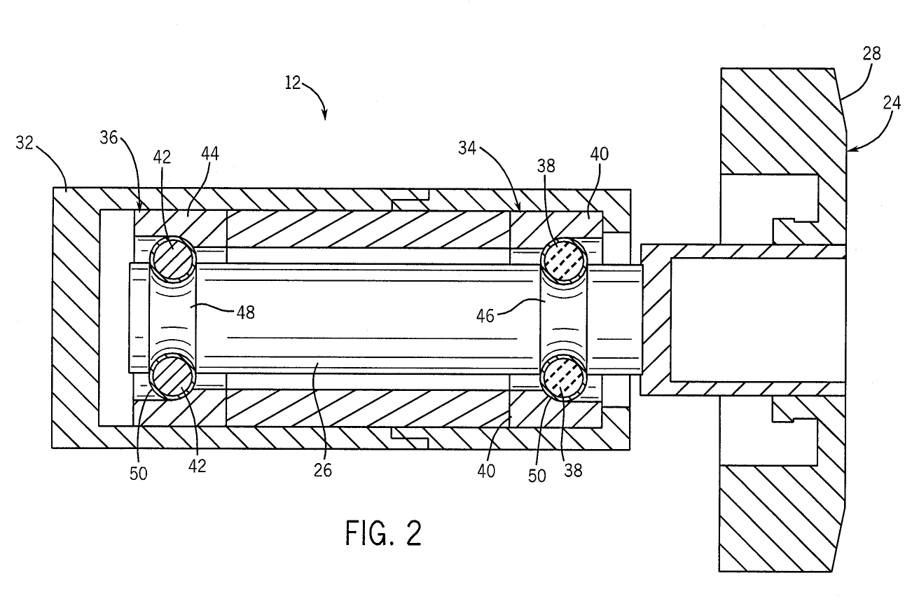

Referring to FIG. 2, a more detailed sectional view of the anode assembly 12 is shown. The anode assembly 12 includes a front bearing assembly 34 and a rear bearing assembly 36 adapted to rotatably support the anode shaft 26 within the anode housing 32. The front bearing assembly 34 includes a first plurality of bearing balls 38 and a first outer race 40 configured to retain the first plurality of bearing balls 38 in a radially outward direction. Similarly, the rear bearing assembly 36 includes a second plurality of bearing balls 42 and a second outer race 44 configured to retain the second plurality of bearing balls 42 in a radially outward direction. The anode shaft 26 defines a first bearing groove 46 and second bearing grove 48 which are respectively adapted to retain the first and second plurality of bearing balls 38, 42 in a radially inward direction.

Heat from the anode 24 is transferred to the bearing assemblies 34, 36 and can impact bearing performance and durability. A bearing device designed to operate optimally at a first temperature can lock-up and interrupt or impede rotation when exposed to higher temperatures because of the thermal expansion of the bearing components. As an example, if the bearing balls 42 are exposed to heat and thermally expand, they may become compressed between the anode shaft 26 and the outer race 44 such that the individual bearing balls 42 cannot rotate (i.e., are locked-up). If the bearing balls 42 lock-up, the rotational resistance applied to the anode shaft 26 significantly increases such that anode 24 rotation is either interrupted or greatly impeded. The bearing assemblies 34, 36 must therefore be designed with enough radial clearance to accommodate for thermal expansion. Excess radial bearing clearance can, however, reduce bearing life due to its adverse effect on bearing design criteria such as bearing contact angle, internal pre-load, and load distribution. It should therefore be appreciated that bearing performance and durability can be improved by reducing radial bearing clearance as long as there remains enough clearance to accommodate for thermal expansion of the bearing components.

As the front bearing assembly 34 is in closer proximity to the anode 24, it receives more heat and higher loads than the rear bearing assembly 36. Therefore, the first plurality of bearing balls 38 are preferably comprised of silicon nitride (Si3N4) which has a thermal expansion that is appreciably less than that of more conventional ball bearing materials such as steel. The reduction in thermal expansion allows the front bearing assembly 34 to be designed with less radial bearing clearance, and the reduction in radial bearing clearance allows for a more consistently optimal bearing contact angle and a more even load distribution such that the performance and durability of the front bearing assembly 34 are improved. Additional improvements in bearing performance and durability can be realized by the smoother surface finish and increased hardness attainable with ceramic materials. While the composition of the first plurality of bearing balls 38 has been described in accordance with the preferred embodiment as including silicon nitride, it should be appreciated that other ceramic compositions such as silicon carbide, alumina oxide, or zirconia may also be envisioned.

The second plurality of bearing balls 42 are preferably comprised of steel. Because the steel balls are used exclusively in the rear bearing assembly 36 which is exposed to less heat and lighter loads than the front bearing assembly 34, the radial clearance of the rear bearing assembly 36 can also be minimized to improve bearing performance and durability. Advantageously, steel has a relatively high electrical conductivity such that the second plurality of bearing balls 42 may be implemented to transfer electrical current (not shown) from the anode 24. While the composition of the second plurality of bearing balls 42 has been described in accordance with the preferred embodiment as including steel, it should be appreciated that other conductive compositions such as other metallic materials may also be envisioned.

The bearing assemblies 34, 36 are preferably dry meaning that fluid lubricants such as grease are not implemented. This requirement is drawn to the fact that the high temperatures to which the bearing assemblies 34, 36 are exposed could vaporize such lubricants and thereby disrupt the vacuum 16 (shown in FIG. 1) within the vessel 18 (shown in FIG. 1). Therefore, according to the preferred embodiment, each of the first and second plurality of bearing balls 38, 42 are coated with a solid lubricant such as silver (Ag), gold (Au), or any other known solid lubricant including NiCuAg, TiAg, Pb, and Pb—Sn. Additionally, the solid lubricant coating 50 may include multiple layers each comprising one or more known solid lubricant material. In accordance with another embodiment of this invention, the solid lubricant coating 50 may be sufficiently conductive to facilitate the transfer of electrical current (not shown) from the anode 24 in a manner similar to that described hereinabove with respect to the second plurality of bearing balls 42. The solid lubricant coating 50 may be applied, for example, with an ion plating method. Techniques such as bond layer coating and multilayer coating may be implemented to enhance the coating adhesion and thermal stability of the coating 50.

According to an embodiment of the invention, the first outer race 40 and the second outer race 44 each include a ball bearing contact surface having a solid lubricant coating. The core material composition of the first and second outer race 40, 44 is preferably steel, and the solid lubricant coating is preferably comprised of Ag, Au, or any other known solid lubricant material. The solid lubricant coating of the first and second outer race 40, 44 may comprise multiple layers and may be applied, for example, with an ion plating method. By applying a solid lubricant coating to the first and second plurality of bearing balls 38, 42, and to the first and second outer race 40, 44, the coefficient of friction of the bearing assemblies 34, 36 can be minimized such that bearing performance and durability are improved.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

I claim:

1. An anode assembly for an x-ray device comprising:
an anode;
an anode shaft mounted to the anode; and
a plurality of ceramic bearing balls circumscribing the anode shaft, said plurality of ceramic bearing balls being adapted to rotatably support the anode shaft.

2. The anode assembly of claim 1, wherein said plurality of ceramic bearing balls are comprised of silicon nitride.

3. The anode assembly of claim 1, further comprising a plurality of metallic bearing balls circumscribing the anode shaft, said plurality of metallic bearing balls being adapted to rotatably support the anode shaft.

4. The anode assembly of claim 3, wherein said plurality of metallic bearing balls are comprised of steel.

5. The anode assembly of claim 3, wherein said plurality of ceramic bearing balls and said plurality of metallic bearing balls each have a solid lubricant coating.

6. The anode assembly of claim 5, wherein said solid lubricant coating is comprised of a material is selected from the group consisting of Ag, Au, NiCuAg, TiAg, Pb, and Pb—Sn.

7. The anode assembly of claim 1, further comprising an outer race circumscribing the plurality of ceramic bearing balls, said outer race adapted to retain the plurality of ceramic bearing balls in a radially outer direction.

8. The anode assembly of claim 7, wherein the outer race has a solid lubricant coating comprised of a material is selected from the group consisting of Ag, Au, NiCuAg, TiAg, Pb, and Pb—Sn.

9. The anode assembly of claim 1, wherein said anode shaft defines a bearing groove adapted to retain the plurality of ceramic bearing balls in a radially inner direction.

10. An anode assembly for an x-ray device comprising:
an anode;
an anode shaft mounted to the anode;
a plurality of metallic bearing balls circumscribing the anode shaft, said plurality of metallic bearing balls each having a solid lubricant coating, said plurality of metallic bearing balls adapted to rotatably support the anode shaft; and
a plurality of ceramic bearing balls circumscribing the anode shaft, said plurality of ceramic bearing balls being positioned axially between the anode and the plurality of metallic bearing balls, said plurality of ceramic bearing balls each having said solid lubricant coating, said plurality of ceramic bearing balls adapted to rotatably support the anode shaft.

11. The anode assembly of claim 10, wherein said plurality of metallic bearing balls are comprised of steel and said plurality of ceramic bearing balls are comprised of silicon nitride.

12. The anode assembly of claim 10, wherein said solid lubricant coating is comprised of a material is selected from the group consisting of Ag, Au, NiCuAg, TiAg, Pb, and Pb—Sn.

13. The anode assembly of claim 10, further comprising a first outer race circumscribing the plurality of metallic bearing balls, and a second outer race circumscribing the plurality of ceramic bearing balls, said first and second outer races being respectively adapted to retain the plurality of metallic bearing balls and the plurality of ceramic bearing balls in a radially outer direction.

14. The anode assembly of claim 13, wherein said first outer race and said second outer race have said solid lubricant coating.

15. The anode assembly of claim 10, wherein said anode shaft defines a first bearing groove adapted to retain the plurality of metallic bearing balls in a radially inner direction, and the anode shaft defines a second bearing groove adapted to retain the plurality of ceramic bearing balls in a radially inner direction.

16. An x-ray device comprising:
a vacuum enclosure;
a cathode assembly at least partially disposed within the vacuum enclosure; and
an anode assembly at least partially disposed within the vacuum enclosure, said anode assembly being positioned to receive electrons from said cathode assembly, said anode assembly including:
an anode;
an anode shaft mounted to the anode;
a plurality of steel bearing balls circumscribing the anode shaft, said plurality of steel bearing balls each having a solid lubricant coating, said plurality of steel bearing balls adapted to rotatably support the anode shaft; and
a plurality of ceramic bearing balls circumscribing the anode shaft, said plurality of ceramic bearing balls being positioned axially between the anode and the plurality of steel bearing balls, said plurality of ceramic bearing balls each having said solid lubricant coating, said plurality of ceramic bearing balls adapted to rotatably support the anode shaft.

17. The x-ray device of claim 16, wherein said plurality of ceramic bearing balls are comprised of silicon nitride.

18. The x-ray device of claim 16, wherein said solid lubricant coating is comprised of a material is selected from the group consisting of Ag, Au, NiCuAg, TiAg, Pb, and Pb—Sn.

19. The x-ray device of claim 16, wherein the anode assembly further comprises a first outer race circumscribing the plurality of steel bearing balls, and a second outer race circumscribing the plurality of ceramic bearing balls, said first and second outer races being respectively adapted to retain the plurality of steel bearing balls and the plurality of ceramic bearing balls in a radially outer direction.

20. The x-ray device of claim 16, wherein said anode shaft defines a first bearing groove adapted to retain the plurality of steel bearing balls in a radially inner direction, and the anode shaft defines a second bearing groove adapted to retain the plurality of ceramic bearing balls in a radially inner direction.
